(19) United States
(12) Patent Application Publication
(10) Pub. No.: US 2007/0201429 A1
(43) Pub. Date: Aug. 30, 2007

(54) Method For Billing A Service In A Packet Data Network

(76) Inventors: Raffaela Brodt, Wr. Neudorf (AT); Florian Bolka, Alland (AT); Daniel Freiberger, Modling (AT); Gabriel Gudenus, Wien (AT); Helmut Haindl, Wien (AT); Christian Jordan, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/571,051

(22) PCT Filed: Jul. 21, 2004
(86) PCT No.: PCT/EP04/08158

§ 371 Date: Apr. 2, 2007

(30) Foreign Application Priority Data
Sep. 8, 2003 (DE) 103 41 362.6

(51) Int. Cl. H04L 12/66

(52) U.S. Cl. 370/352; 379/111

(57) ABSTRACT

The invention relates to a method for billing a service in a packet data network (PDN). According to said method, at least one type of billing is associated with at least one service that can be used by a user, and data representing the type and use of the service, in addition to the type of billing associated with the service or selected by the user, is stored during the use of the service selected by the user. The invention also relates to a billing system (VS) for carrying out the inventive method.

### CROSS REFERENCE TO RELATED APPLICATION

This application is the US National Stage of International Application No. PCT/EP2004/008158, filed Jul. 21, 2004 and claims the benefit thereof. The International Application claims the benefits of German Patent application No. 10341362.6 filed Sep. 8, 2003, both of the applications are incorporated by reference herein in their entirety.

### FIELD OF THE INVENTION

The invention relates to a method for billing a service in a packet data network and a billing system provided for carrying out the method according to the invention.

### BACKGROUND OF THE INVENTION

In a packet data network, for example the Internet, a multitude of services is offered. Examples of this are, for instance, the transmission of music and video contents or also Internet telephony as well as the downloading of so-called Internet pages in HTML format. As a rule, a user is granted this access by a so-called Internet provider. Billing takes place, for example at a fixed price specified for a particular period, for instance a “flat rate” to be paid monthly, independently of the actual utilization of the Internet. It is also conceivable that billing is made dependent on the actual utilization. In this context, the access must be paid for, for example, per minute.

According to the prior art, systems are also known which limit the access to the Internet. In this context, access is granted, for example, only to a particular type of services. In this context, the downloading of music and videos can be prohibited but the downloading of Internet pages can be allowed.

In this context, access is made possible for a user via an access router, a so-called “edge router”, in connection with a service selection system, a so-called “service selection portal”. During the dialing into the Internet, the service selection portal is informed by the edge router about the dialing process for this purpose. The service selection portal then determines what services are available for the user and, for example, an HTML page with a corresponding listing is transferred to the user, which also enables a service to be selected. After the selection by the user, the edge router is instructed by the service selection portal to enable the required connection for the utilization of the service.

In this arrangement, the Internet provider determines, for example in dependence on a billing model, what services should be available in principle. The provider can offer various service packets at different prices so that, for example, linear downloading of Internet pages is offered more inexpensively than the utilization of all services possible on the internet. Billing is again at a flat rate or time-dependent.

In this arrangement, it is unsatisfactory both for the user and for the service provider that the billing of a service packet does not differentiate between whether and for how long a service, which may be expensive with regard to the required bandwidth, like the downloading of a video film, is actually used. This means that the user must also pay for the mere possibility of utilization of this service even if he does not use a particular service during an accounting period.

### SUMMARY OF THE INVENTION

It is, therefore, the object of the invention to specify a method and a device which improve the billing of a service in a packet data network.

This object is achieved by means of a method of the type initially mentioned
in which at least two billing types are allocated to a service and in which, when the service is utilized, data on the utilization of the service and a billing type selected by the user are stored, or
in which a number of usable services are allocated to a user to which in each case at least one billing type is allocated and in which, when the service selected by the user is utilized, data on the type and utilization of the service and a billing type allocated to the service or a billing type selected by the user are stored.

In the first variant of the invention, two or more billing types are allocated to a service. It is also conceivable that the downloading of a video film is billed overall per film, per data volume transmitted or, for example, in accordance with the transmission time. It is also conceivable that various transmission rates are offered for this which are also billed differently. Thus, the user has the possibility here of selecting a charge model suitable for him.

In the second variant, a number of services are offered for utilization which are, in each case, allocated at least one charge type. Thus, the user can decide here whether he wishes to use relatively expensive services or not. In this arrangement, a number of charge types can again be allocated to a service, for example high and expensive transmission bandwidths or low and inexpensive transmission bandwidths.

Compared with the prior art, the users' satisfaction can thus be improved considerably.

In this context, it is advantageous
if, during the registration of the user in the packet data network, the services usable by a user are transmitted by a service selection portal to a billing system,
if these services are linked in the billing system with billing types, the allocation of which to the services are stored in the billing system, and
if from this a selection list containing the usable services and their billing types is generated and transmitted to the user terminal.

In this arrangement, a service selection portal according to the prior art is advantageously tied into the inventive method, which is why the latter can be implemented with comparatively little expenditure.

During the dialing into the packet data network, the service selection portal determines what services are available for the user. As a consequence, however, no listing of the services is transmitted to the user terminal as in the prior art, but instead the services are first linked with the billing types, the allocation to the services of which are stored in the billing system, still in the billing system. As a result, it is possible to offer the user a service-dependent billing.

An advantageous variant of the invention is given by means of a method
in which the service selection portal receives from the billing system information on which service has been selected, and
in which the service selection portal thereupon instructs an edge router to enable the connections required for the service.

As already mentioned, a listing of the services which also enables a service to be selected is transmitted to the user terminal. As a consequence, the choice of the user is transmitted via the service selection portal to the billing system, where it is evaluated. Finally, the edge router is instructed by the service selection portal to enable the required connection for the utilization of the service. Due to this tying of the invention into a system known from the prior art, comfortable operation by the user also remains ensured.

It is advantageous if information on a billing type allocated to the service or selected by the user is stored in the service selection portal.

The information mentioned is advantageously stored here in order to be able to access it again at a later time, for example for accounting purposes.

It is also advantageous
if the data relevant to the network access are registered by the access server and forwarded to the billing system,
if the data obtained are linked there with the billing type allocated to the selected service or selected by the user, and
if a billing record resulting from the linking is stored in the billing system.

According to the prior art, the data relevant to the network access, such as, for example, access time, duration and transmission bandwidth used, are registered by the access server. According to the invention, these data are then forwarded to the billing system where they are linked with the billing type allocated to the selected service or selected by the user and a corresponding billing record is stored. Thus, a service-dependent billing can be advantageously implemented in a simple manner.

It is also particularly advantageous
if user-specific data are read out of the access server by the billing system
if the data obtained are linked in the billing system with the billing records stored therein, a bill is generated therefrom and this is transmitted to the user terminal.

In this manner, the user has access to a current account of the costs incurred by him. This is thus no longer tied to accounting periods which are predetermined, for example by the operator of the packet data network.

The object of the invention is also achieved by means of a billing system for billing a service in a packet data network
in which it comprises means for allocating at least two billing types to a service and means for storing data about the utilization of the service and a billing type selected by the user, or
in which it comprises means for allocating in each case at least one billing type to a number of services usable by a user and means for storing data about the type and utilization of the service and a billing type allocated to the service or selected by the user.

The advantages listed in the method according to the invention similarly also apply to the billing system according to the invention. A corresponding possibility of selection of a billing model by the user thus makes it possible to considerably improve the satisfaction of the latter compared with the prior art.

In this context, it is advantageous
if it comprises means for receiving the services usable by a user from a service selection portal,
if it comprises means for linking these services with billing types, the allocations of which to the services are stored in the billing system,
if it comprises means for generating from this linkage a selection list which contains services and their billing, and
if it comprises means for sending this selection list to the user terminal.

In this arrangement, the billing system is advantageously tied into an arrangement known from the prior art.

This comprises means for linking available services with predefined billing types, means for generating a selection list which contains services and their billing types, and means for sending this selection list to the user terminal. A selection list according to the prior art is, therefore, advantageously extended by a billing type allocated to each service by the billing system according to the invention.

An advantageous variant of the invention is also given with a billing system
which comprises means for receiving the data relevant to the network access,
which comprises means for linking the data obtained with the billing type allocated to the selected service or selected by the user, and
in which means exist for storing a billing record resulting from the linkage.

According to the prior art, the data relevant to the network access, such as, for example, access time, duration and transmission bandwidth used, are registered by the access server. The billing system according to the invention then comprises means for receiving and linking these data with a billing type and means for storing a corresponding billing record. In this manner, a billing system for service-dependent billing can be implemented with comparatively little technical expenditure.

It is particularly advantageous
if the billing system comprises means for receiving user-specific data,
if the billing system comprises means for linking the data obtained with the stored billing records,
if the billing system comprises means for generating a bill from these data and
if the billing system comprises means for sending this bill to the user terminal.

This billing system enables a user for the first time to access a current account of the costs incurred by him. He is thus no longer tied to accounting periods predetermined by the operator of the packet data network.

### BRIEF DESCRIPTION OF THE DRAWINGS

The invention will be explained in greater detail with reference to an exemplary embodiment shown in the figures, which relates to the billing of services in a packet data network according to the invention.

In the figures:

FIG. 1 shows how the billing system VS according to the invention is tied into a packet data network PDN;

FIG. 2 shows the registration of the user in the packet data network PDN;

FIG. 3 shows the method in storing the billing data;

FIG. 4 shows the user's inquiry regarding his current bill.

### DETAILED DESCRIPTION OF THE INVENTION

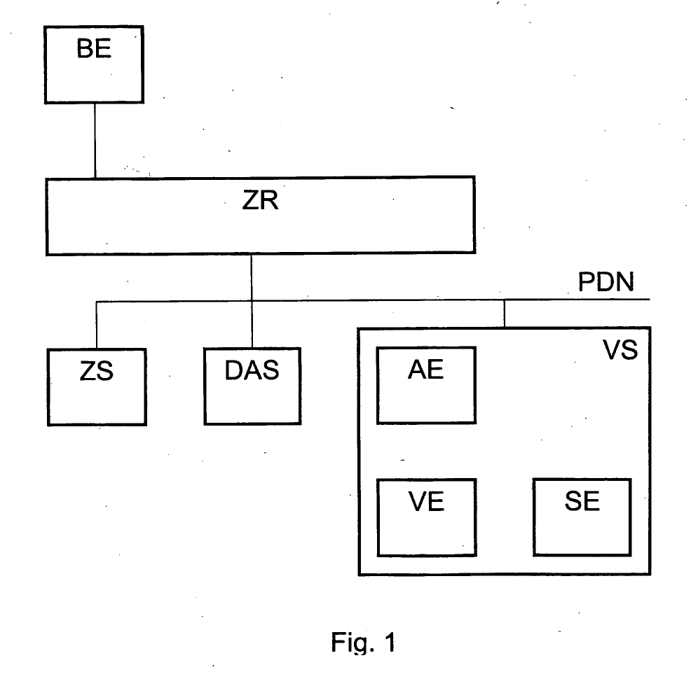

FIG. 1 shows how the billing system VS according to the invention is tied into a packet data network PDN. The figure comprises a user terminal BE, an edge router ZR, an access server ZS, a service selection portal DAS and the billing system VS. The latter comprises a selection device AE, an administrative device VE and a storage device SE. In the example shown, the user terminal BE is connected via the edge router ZR to the packet data network PDN which connects the edge router ZR, the access server ZS, the service selection portal DAS and billing system VS and other devices, not shown, with one another. Examples of this are devices of service providers which the user wishes to access.

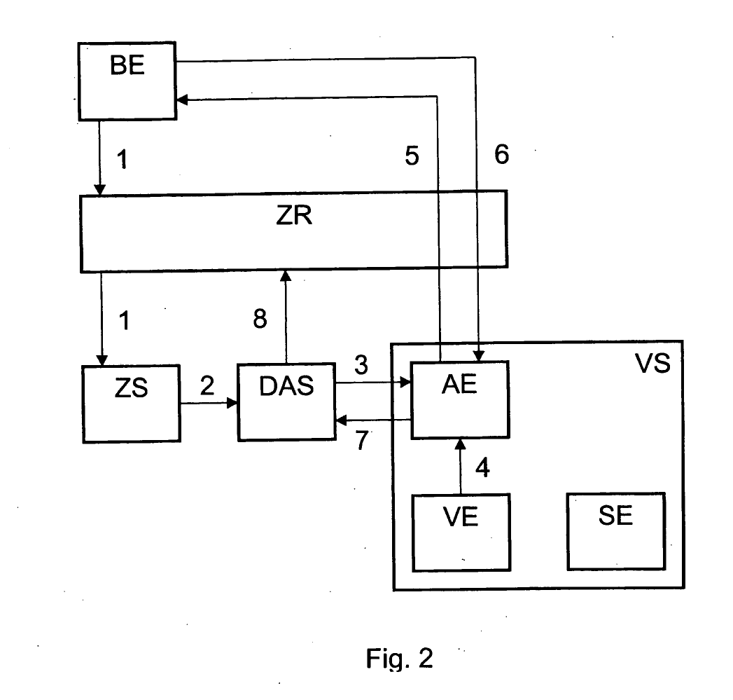

The operation of the arrangement shown in FIG. 1 is as follows, the connections between the individual devices not being shown in the subsequent FIGS. 2 to 4, for the sake of better clarity, but only the method steps being entered.

FIG. 2 shows the registration of the user in the packet data network PDN. In a first step 1, the user is authenticated in the access server. If he is recognized, user-specific information is communicated in a second step 2 to the service selection portal DAS, from where it is forwarded, together with the services usable by the user, to the selection device AE of the billing system VS in a third step 3. In a fourth step 4, the billing types allocated to the services are transmitted from the administrative device VE to the selection device AE where the information obtained in steps 3 and 4 is linked, a selection list is generated and the latter is sent to the user terminal BE in a fifth step 5. The selection made by the user is sent back to the selection device AE in a sixth step 6, the relevant data like the billing type allocated to the selected service or a billing type selected by the user being stored. In a seventh step 7, the selected service is then communicated to the service selection portal DAS which finally instructs the edge router ZR in a eighth step 8 to enable the connections required for the selected service as a result of which the user is granted access to the desired service.

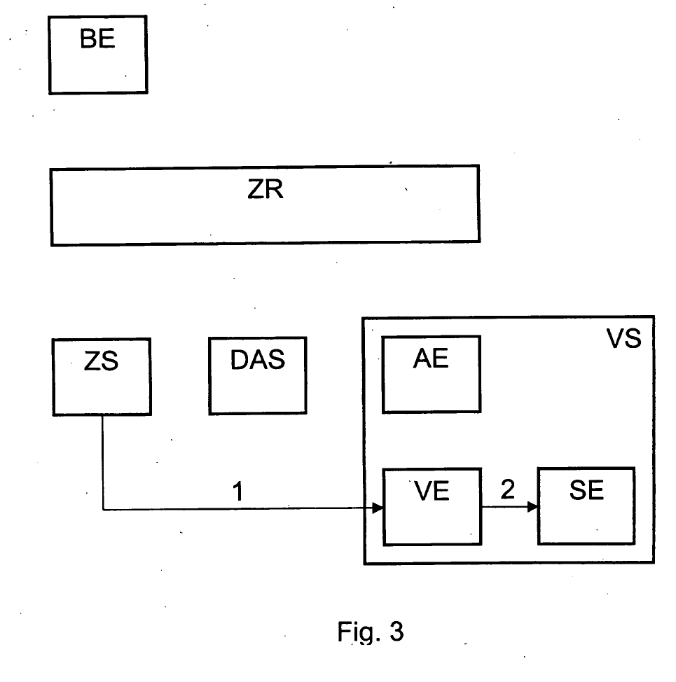

From FIG. 3, it can then be seen how the billing data are stored. In this arrangement, the data relevant to the network access, such as, for example, bandwidth and access duration, are registered by the access server ZS and forwarded to the administrative device VE in a first step 1. The data obtained are linked there with the billing type allocated to the selected service or selected by the user and the result is transferred into the storage device SE in a second step 2. These data can also be forwarded in a suitable format to third parties which need these data, for example for accounting purposes, if required.

In this context, the access server ZS is also known by the term “Authorization, Authentication and Accounting Server”, AAA server for short. In this respect, see also:
RFC 2903, Experimental, “Generic AAA Architecture”, C. de Laat, G. Gross, L. Gommans, J. Vollbrecht, D. Spence, August 2000;
RFC 2904, Informational, “AAA Authorization Framework” J. Vollbrecht, P. Calhoun, S. Farrell, L. Gommans, G. Gross, B. de Bruijn, C. de Laat, M. Holdrege, D. Spence, August 2000;
RFC 2905, Informational, “AAA Authorization Application Examples” J. Vollbrecht, P. Calhoun, S. Farrell, L. Gommans, G. Gross, B. de Bruijn, C. de Laat, M. Holdrege, D. Spence, August 2000 and
RFC 2906, Informational, “AAA Authorization Requirements” S. Farrell, J. Vollbrecht, P. Calhoun, L. Gommans, G. Gross, B. de Bruijn, C. de Laat, M. Holdrege, D. Spence, August 2000

A protocol used for communicating with the AAA server is known by the name “Remote Authentication Dial In User Service”, or RADIUS for short. In this respect see also:
RFC 2865, “Remote Authentication Dial In User Service (RADIUS), by C. Rigney, S. Willens, A. Rubens, W. Simpson. June 2000 and
RFC 2869, “RADIUS Extensions”, by C. Rigney, W. Willats, P. Calhoun. June 2000.

A further protocol which is suitable for communication with the AAA server is the so-called “Lightweight Directory Access Protocol”, called LDAP for short. In this regard, see also RFC 2251, “Lightweight Directory Access Protocol” by M. Wahl, T. Howes, S. Kille, December 1997.

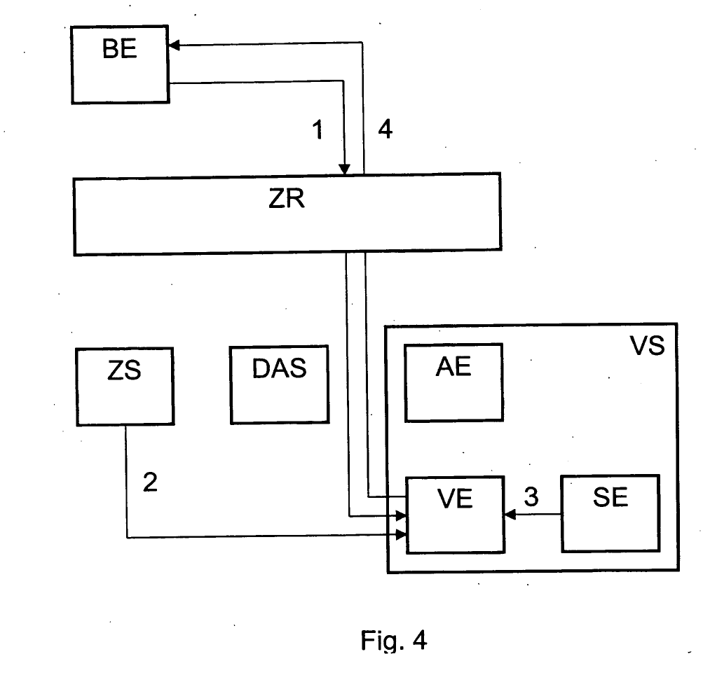

FIG. 4, finally, shows the user's inquiry regarding his current bill. For this purpose, a corresponding request is made to the administrative device VE in a first step 1. In a second step 2, user-specific information is then read out of the access server ZS and transferred to the administrative device VE in order to be able to take into consideration also any active connection into the packet data network PDN for the account. Following this, the charge data stored in the storage device SE are transferred in a third step 3 to the administrative device VE. The information obtained from the second and third step 2 and 3 are combined there, a bill is generated from this and is transmitted in a fourth step 4 to the user terminal BE where it is displayed.

1-10. (canceled)

11. A method for billing a service in a packet data network, comprising:
allocating at least two billing types to the service; and
utilizing the service such that data on the utilization of the service and a billing type selected by the user are stored.

12. The method as claimed in claim 11, wherein during the registration of the user in the packet data network, the services usable by a user are transmitted by a service selection portal to a billing system with these services linked in the billing system with billing types, the allocation of which to the services are stored in the billing system and from this a selection list containing the usable services and their billing types is generated and transmitted to the user terminal.

13. The method as claimed in claim 12, wherein the service selection portal receives from the billing system information on which service has been selected, and the service selection portal then instructs an edge router to enable the connections required for the service.

14. The method as claimed in claim 13, wherein the information on a billing type allocated to the service or selected by the user is stored in the service selection portal.

15. The method as claimed in of claim 13, wherein the data relevant to the network access are registered by the access server and forwarded to the billing system, the data obtained are linked there with the billing type allocated to the selected service or selected by the user, and a billing record resulting from the linkage is stored in the billing system.

16. The method as claimed in claim 15, wherein the user-specific data are read out of the access server by the billing system, the data obtained are linked in the billing system with the billing records stored therein, a bill is generated therefrom and then transmitted to the user terminal.

17. A billing system for billing a service in a packet data network, comprising:
a device for allocating at least two billing types to a service; and
a device for storing data about the utilization of the service and a billing type selected by the user.

18. The billing system as claimed in claim 17, wherein the billing system further comprises a device for receiving the services usable by a user from a service selection portal, a device for linking these services with billing types the allocations of which to the services are stored in the billing system, a device for generating from this linkage a selection list which contains services and their billing types, and a device for sending this selection list to the user terminal.

19. The billing system as claimed in claim 18, further comprising a device for receiving the data relevant to the network access, a device for linking the data obtained with the billing type allocated to the selected service or selected by the user, and a device for storing a billing record resulting from the linkage.

20. The billing system as claimed in claim 19, further comprising a device for receiving user-specific data, a device for linking the data obtained with the stored billing records, a device for generating a bill from these data, and a device for sending this bill to the user terminal.
